(19) United States
(12) Patent Application Publication
(10) Pub. No.: US 2004/0074270 A1
(43) Pub. Date: Apr. 22, 2004

(54) Reclining seats for cargo compartments

(76) Inventor: Antonio M. Arias, Panama (PA)

Correspondence Address: John H. Oltman, Oltman, Flynn & Kubler, 915 Middle River Drive #415, Ft. Lauderdale, FL, 33304-3585, US

(21) Appl. No.: 10/682,829

(22) Filed: Oct. 10, 2003

Related U.S. Application Data
(63) Continuation-in-part of application No. 09/755,896, filed on Jan. 5, 2001, now Pat. No. 6,651,469.

(51) Int. Cl. A47C 31/00; E05B 65/44

(52) U.S. Cl. 70/261

(57) ABSTRACT

A seat retainer arrangement for use on the cargo compartment of a pickup truck or the like comprising a substantially rigid, longitudinally extensible and retractable arm member for engagement removably to respective openings on mounting brackets secured to opposite side walls of the cargo compartment is disclosed. The seat used with this seat retainer arrangement has a backrest which can be reclined back and down and a leg rest segment which can be extended up and to the front when said seat is engaged to said arm member and said arm member is secured to said openings on said mounting brackets on opposite side walls of the cargo compartment. Additionally, the legs of the seat are extensible and retractable so that the seat rests on the bottom of the cargo compartment even when the mounting brackets are installed on the side walls of cargo compartments of different pickup trucks having different heights.

### FILING HISTORY

This application is a continuation in part of application Ser. No. 09/755,896 filed on Jan. 5, 2001.

### BACKGROUND OF THE INVENTION

Field of the Invention

This invention relates to a novel arrangement for retaining seats in place in the cargo compartment of pickup trucks so that such trucks can carry comfortably seated passengers both in their cabs and cargo compartments. Truck cargo compartments are designed to transport cargo, not people. But by providing a fast and convenient means to retain seats in place in said compartments, that also allows truck users to detach the seats easily and instantly therefrom, said compartments would become more versatile and useful to truck users who would occasionally prefer to travel in an open or more natural environment, specially in off the road trips, to inspect a field, farm, forest or park. Additionally, the seat retainer provides a key to releasably lock the seats to such open-topped cargo compartments and thus secure the seats against theft.

### SUMMARY OF THE INVENTION

The principal object of the present invention is to provide an arrangement to conveniently retain seats in place in the cargo compartment of pickup trucks, that also allows truck users to detach the seats easily and instantly therefrom, so that such compartments can be readily used to transport either people or cargo. The retained seats have reclinable backrests which can be pivoted back and down and leg support segments which can be extended up and to the front of the seat. Additionally, the seat retainer provides a key to releasably lock the seats to such open-topped cargo compartments and thus secure the seats against theft.

### BRIEF DESCRIPTION OF THE DRAWINGS

FIG. 1 is a top perspective view of a conventional pickup truck.

FIG. 2 shows a pair of mounting brackets having rectangular-shaped openings.

FIG. 3 shows the same mounting brackets secured to opposite side walls of the cargo compartment of a pickup truck.

FIG. 4 shows an arm member engaging the rear of a seat and secured to the mounting brackets illustrated in FIG. 3, to thus retain in place said seat within the truck's cargo compartment.

FIG. 5 shows how the backrest and the leg rest segment of said retained seat can be moved while the seat is secured to said mounting brackets on opposite side walls of the truck's cargo compartment. The backrest can be moved back and down and the leg rest segment up and to the front of the seat.

FIG. 6 shows how the telescopic arm segment securing the seat to the aforementioned mounting brackets passes through a loop located underneath the backrest of the seat so that said backrest can be moved back and down without any interference. This FIGURE shows further that the legs of the seat are also telescopic and thus that said legs can be adjusted up and down so that the seat rests on the bottom of the cargo compartment even when the mounting brackets are installed on the side walls of cargo compartments of different pickup trucks having different heights.

In FIG. 7 a key is shown releasably locking the aforementioned arm member to the rectangular-shaped openings on the mounting brackets installed on opposite side walls of the truck's cargo compartment.

### DETAILED DESCRIPTION OF THE PREFERRED EMBODIMENTS

Before explaining the present invention in detail it is to be understood that the invention is not limited in its application to the particular arrangements shown and described herein since the invention is capable of other embodiments. Also, the terminology used herein is for the purpose of description and not of limitation.

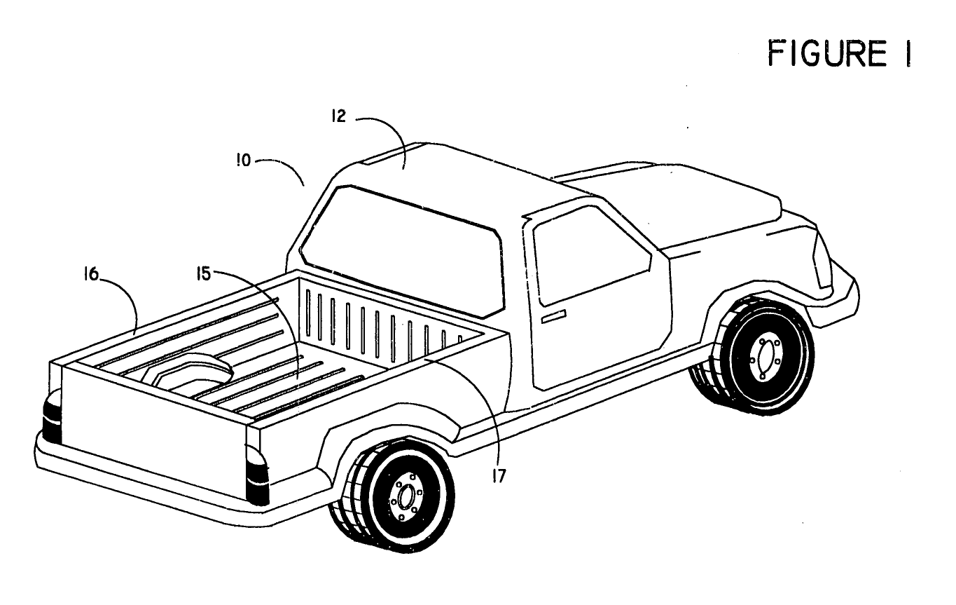

Referring to FIG. 1, a conventional pickup truck 10 has an open-topped cargo compartment or area behind the cab 12. The cargo compartment has a bottom wall 15, front and back sides and two opposite side walls 16 and 17.

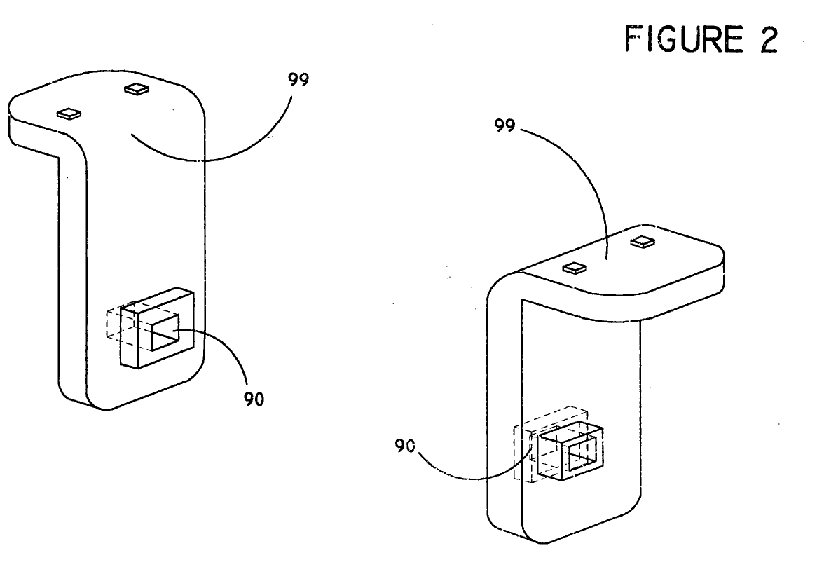

FIG. 2 shows a pair of L-shaped mounting brackets 99 having rectangular-shaped openings 90.

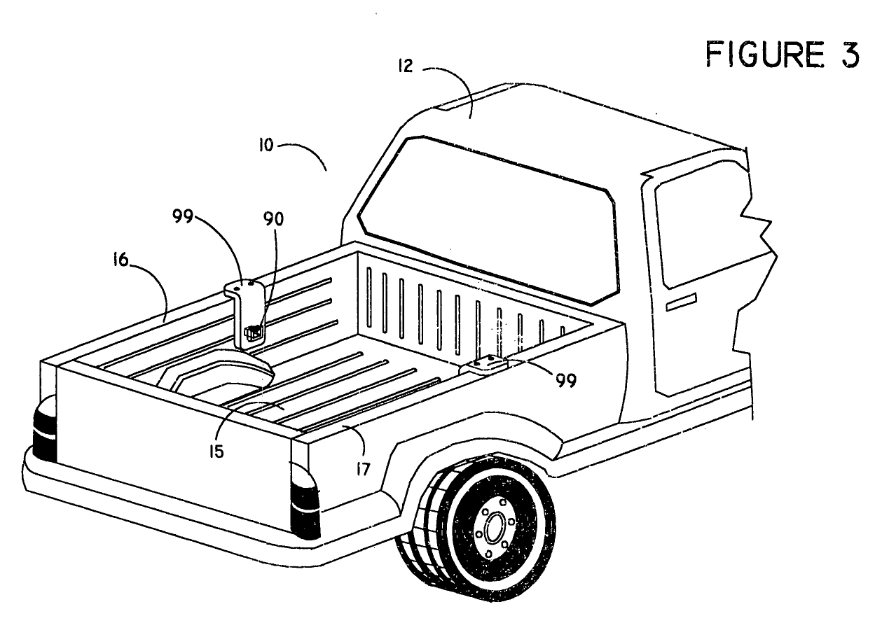

FIG. 3 shows the short segment of the L-shaped mounting brackets 99 rigidly affixed by suitable fasteners (e.g., screws) to a section of the top edge of side walls 16 and 17 so that openings 90 face each other. FIG. 3 shows opening 90 on side wall 16 only of the cargo compartment but it is to be understood that opposite side wall 17 has an identical opening 90 that is aligned, both lengthwise of the truck and vertically, with the opening 90 appearing in FIG. 3. Each opening 90 is spaced above the bottom of the cargo compartment

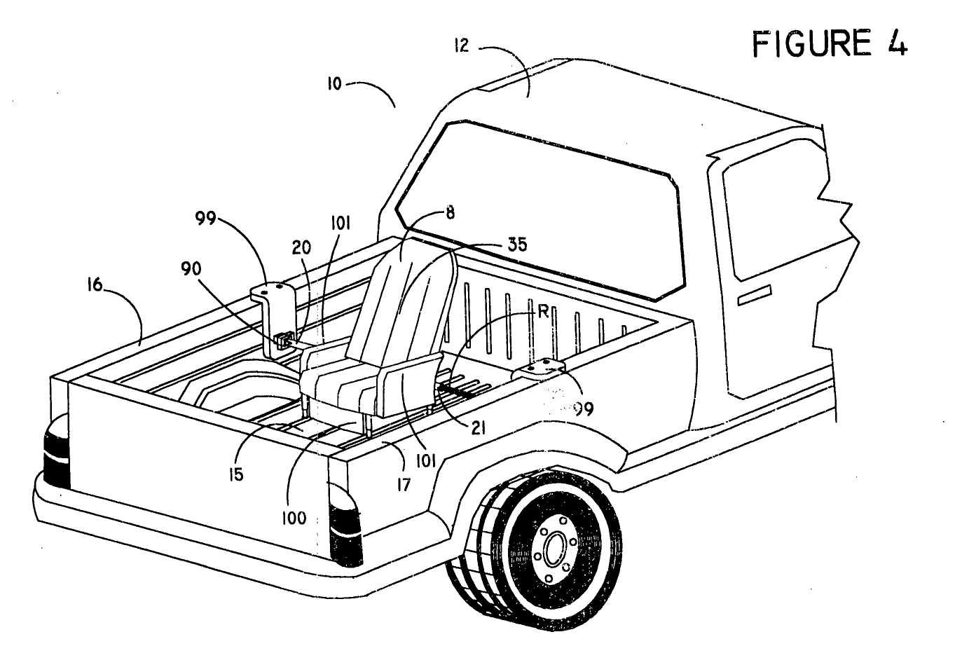

FIG. 4 then shows telescopic arm member R securing removably seat 8 to openings 90 on mounting brackets 99 affixed to opposite side walls 16 and 17 of the cargo compartment of pickup truck 10. Arm member R secures seat 8 a predetermined distance up from the bottom of the seat resting on the bottom of the truck's cargo compartment but below backrest 35 of said seat so that said backrest can be reclined backward and down even when the seat is secured to said arm member R and said arm member R is engaged to said mounting brackets 99 on opposite side walls 16 and 17. Openings 90 receive the laterally outward rectangular ends of the corresponding substantially rigid, longitudinally extensible and retractable seat retainer or arm member R on opposite sides of seat 8 then being carried by the truck.

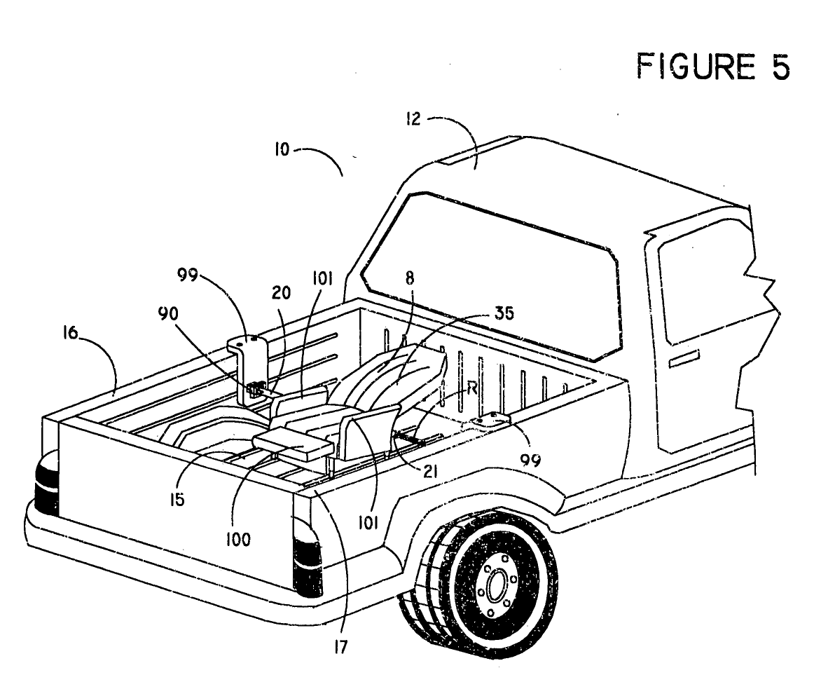

FIG. 5 shows that as said seat 8 is retained in place by arm member R and its backrest 35 is pivoted back and down, its leg rest segment 100 extends up and to the front. FIG. 5 also illustrates armrests 101 on opposite sides of seat 8.

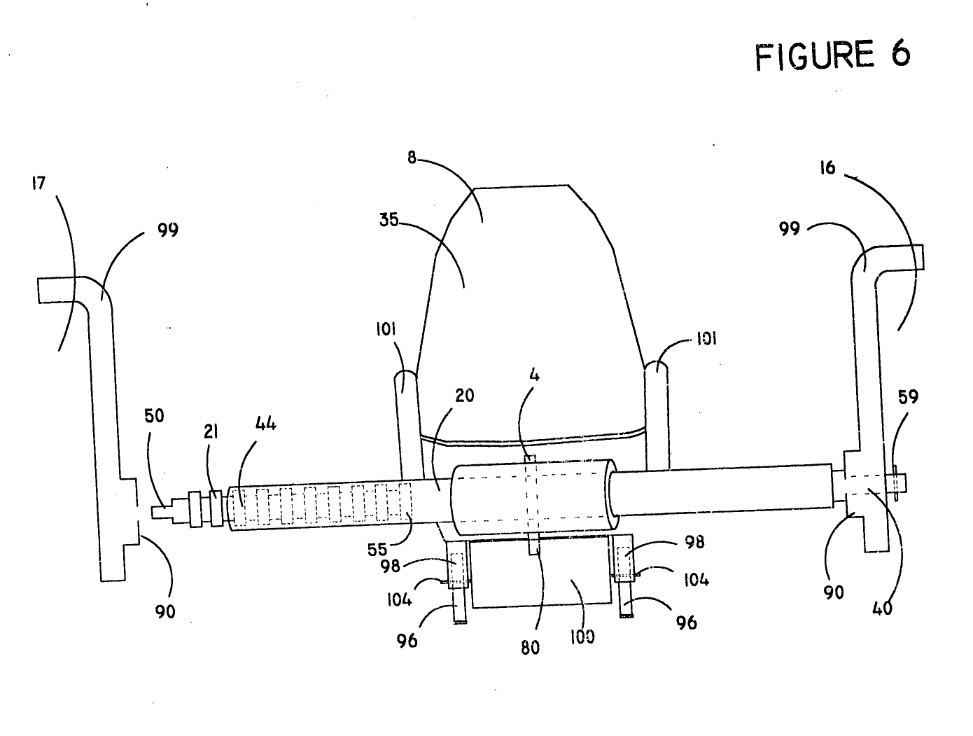

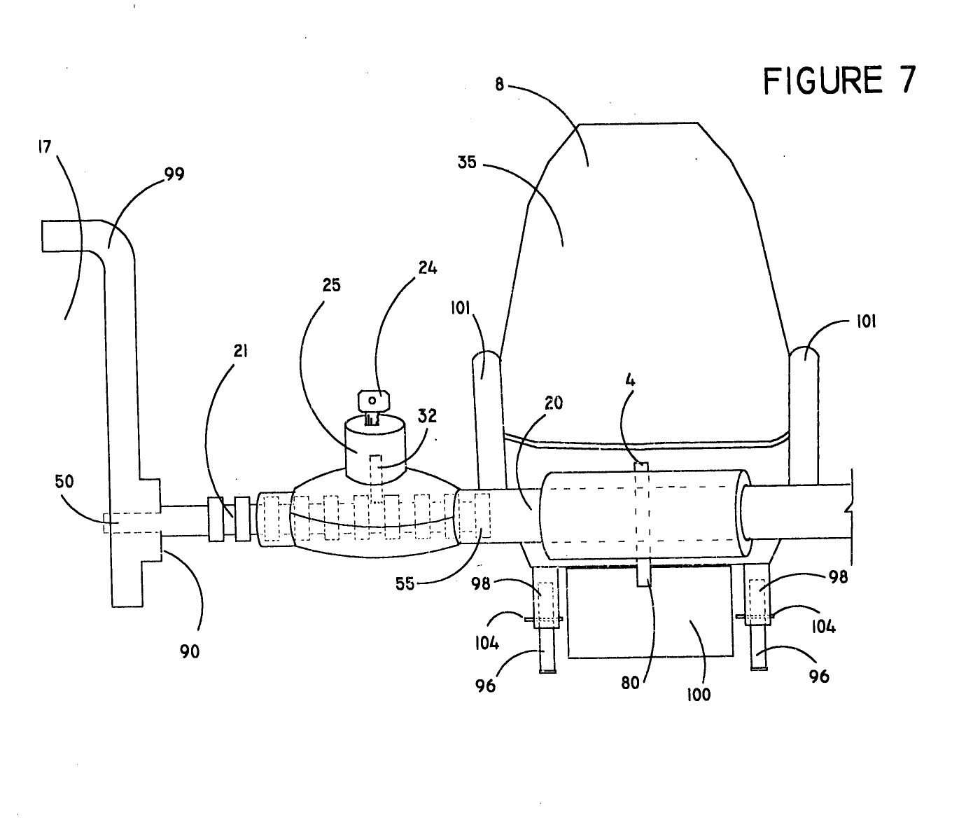

FIG. 6 shows that telescopic arm member R comprises a substantially cylindrical hollow tube or outer sleeve 20 and a solid striated inner shaft or rod 21 which is snugly but slidably received in sleeve 20. In this FIGURE a portion of sleeve 20 is shown passing through a securing loop 4 on the rear of seat 8 with a rectangular cushioned end 40 of the sleeve 20 opposite to the end 44 which receives the shaft 21 snugly fitted inside opening 90 on mounting bracket 99 secured to side wall 16 of the cargo compartment. A rectangular cushioned end 50 of the striated shaft 21 opposite to the end 55 received in the sleeve 20 is also shown about to be fitted inside a respective opening 90 on a mounting bracket 99 affixed to opposite side wall 17 of the cargo compartment. A pin 80 is also shown extending through coinciding holes on sleeve 20 and securing loop 4 on the rear of seat 8. The purpose of the pin is to prevent the seat from sliding towards either side wail 16 or 17 of the cargo compartment. The pin is secured removably. As already noted, securing loop 4 is located under backrest 35 of the seat so that said backrest can be reclined backwards and down even when the seat is secured to arm member R and side walls 16 and 17 of the cargo compartment.

FIG. 6 also shows that seat 8 need not be retained in place with both ends of arm member R secured to openings 90 on mounting brackets 99. Seat 8 can optionally be retained in place with only one end of arm member R secured to a mounting bracket 99. In this FIGURE seat 8 is shown secured only to the mounting bracket affixed to side wall 16 of the cargo compartment. A pin 59 passes through a hole on the outer portion of rectangular end 40 which extends through and beyond the long segment of mounting bracket 99, to thereby lock said rectangular end to said mounting bracket 99 on said side wall 16, even when the counterpart rectangular end 50 of striated shaft 21 does not even contact its corresponding mounting bracket 99 affixed to opposite side wall 17. This second preferred arrangement whereby the seat is retained in place from only one side wall may be of interest in such cases when arm member R interferes with certain pieces of cargo placed adjacent to the opposite side wall of the cargo compartment.

FIG. 6 further shows that the legs of seat 8 are telescopic and comprised of an upper longitudinal member 98 which receives a lower longitudinal member 96. Pin 104 locks said lower member 96 to upper member 98 at any of various points. The legs of seat 8 are thus extensible and retractable so that the seat rests on the bottom 15 of the cargo compartment even when mounting brackets 99 are installed on the side walls of cargo compartments of different pickup trucks having different heights.

In FIG. 7 a key 24 is then shown releasably locking shaft 21 to sleeve 20 after the shaft has been slided outwardly to the point where rectangular end 50 of the striated shaft is snugly fitted inside opening 90 and the long segment of mounting bracket 99 on side wall 17 does not allow the shaft to be extended out of the sleeve any further.

Key 24 is rotatably adjustable within chamber 25 on sleeve 20. As the key is turned it extends outwardly a small pin 32 to obstruct the movement of striated shaft 21 within sleeve 20 and thus lock the shaft after the shaft is slided outwardly to the extent shown in FIG. 7. Conversely, as the key is returned to its original position pin 32 retracts inside chamber 25 to allow the striated shaft 21 to retract again inside sleeve 20.

To detach seat 8 from openings 90 on mounting brackets 99 on side walls 16 and 17, shaft 21 would be retracted inside sleeve 20 after key 24 unlocks the shaft from the sleeve. Pin 80 extending through coinciding holes on securing loop 4 and sleeve 20 would also be unlocked and removed, to thus unlock also the sleeve from securing loop 4 and slidably remove the sleeve from said securing loop so that the seat can be used as any other ordinary seat, unconnected to the sleeve and the cargo compartment of pickup truck 10.

I claim as my invention:

1. In combination with a truck with a cargo compartment having a bottom wall, front and back sides and opposite side walls extending up from said bottom wall, at least one seat having a redinable backrest and at least one arm engageable with said seat and at least one mounting bracket;
wherein said mounting bracket is secured to at least one of said opposite side walls to secure at least one said arm; and whereby said backrest can be reclined backward and down when said arm is secured to said seat and at least one said mounting bracket on at least one of said opposite side walls.

2. In combination with a truck with a cargo compartment having a bottom wall, front and back sides and opposite side walls extending up from said bottom wall, at least one seat having an adjustable support structure and a reclinable backrest and at least one arm engageable with said seat and at least one mounting bracket;
wherein said mounting bracket is secured to at least one of said opposite side walls to secure at least one said arm; and whereby said backrest can be reclined backward and down when said arm is secured to said seat and at least one said mounting bracket on at least one of said opposite side walls; and whereby said support structure can be adjusted so that said seat rests on said bottom wall even when said mounting bracket is installed at different heights from said bottom wall.

3. In combination with a truck with a cargo compartment having a bottom wall, front and back sides and opposite side walls extending up from said bottom wall, at least one seat which support structure is adjustable and which backrest is reclinable backwards and down and at least one arm engageable with said seat and securing means on at least one of said opposite side walls;
wherein said securing means on at least one of said opposite side walls secures at least one said arm; and whereby said backrest can be reclined backward and down when said arm is secured to said seat and at least one of said opposite side walls; and whereby said support structure is adjustable so that said seat rests on said bottom wall even when said securing means is located at different heights from said bottom wall.

4. In combination with a truck with a cargo compartment having a bottom wall, front and back sides and opposite side walls extending up from said bottom wall, at least one seat which backrest is reclinable backwards and down and at least one arm engageable with said seat and securing means on at least one of said opposite side walls;
wherein said securing means on at least one of said opposite side walls secures at least one said arm; and whereby said backrest can be reclined backward and down when said arm is secured to said seat and at least one of said opposite side walls.

5. In combination with a truck with a cargo compartment having a bottom wall, front and back sides and opposite side walls extending up from said bottom wall, at least one seat with a swingable leg rest segment and a reclinable backrest and at least one arm engageable with said seat and securing means on at least one of said opposite side walls;
wherein said securing means on at least one of said opposite side walls secures at least one said arm; and whereby said leg rest segment can be extended up and to the front of said seat and said reclinable backrest pivoted to swing back and down when said arm is secured to said seat and at least one of said opposite side walls.
